(19) United States
(12) Patent Application Publication
(10) Pub. No.: US 2016/0375663 A1
(43) Pub. Date: Dec. 29, 2016

(54) THERMAL INSULATION WALLBOARD AND METHOD FOR PRODUCING THE SAME

(71) Applicant: NANJING JINGYEDA NEW BUILDING MATERIALS CO., LTD., Nanjing (CN)

(72) Inventors: Mingfang LV, Nanjing (CN); Yiting AN, Nanjing (CN)

(21) Appl. No.: 15/260,291

(22) Filed: Sep. 8, 2016

Related U.S. Application Data
(63) Continuation-in-part of application No. PCT/CN2015/077611, filed on Apr. 28, 2015.

(30) Foreign Application Priority Data
May 23, 2014 (CN) 201410220818.4

(51) Int. Cl. B32B 27/42; B32B 37/14; B32B 38/00; E04B 1/80; B32B 7/04

(52) U.S. Cl. CPC B32B 27/42; E04B 1/80; B32B 7/04; B32B 38/0004; B32B 37/14; B32B 2307/73; B32B 2307/304; B32B 2607/00

(57) ABSTRACT

A thermal insulation wallboard including a thermal insulation board, a first hardened resin layer, a first alkali-resistant glass cloth, a second hardened resin layer, a third hardened resin layer, a second alkali-resistant glass cloth, a fourth hardened resin layer and waterproof interface layers. The first hardened resin layer is arranged on one side of the thermal insulation board. The first alkali-resistant glass cloth is arranged on the external part of the first hardened resin layer. The second hardened resin layer is arranged on the external part of the first alkali-resistant glass cloth. The third hardened resin layer is arranged on the other side of the thermal insulation board. The second alkali-resistant glass cloth is arranged on the external part of the third hardened resin layer. The fourth hardened resin layer is arranged on the external part of the second alkali-resistant glass cloth.

### CROSS-REFERENCE TO RELATED APPLICATIONS

This application is a continuation-in-part of International Patent Application No. PCT/CN2015/077611 with an international filing date of Apr. 28, 2015, designating the United States, now pending, and further claims priority benefits to Chinese Patent Application No. 201410220818.4 filed May 23, 2014. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, and Cambridge, Mass. 02142.

### BACKGROUND OF THE INVENTION

Field of the Invention

The invention relates to a thermal insulation wallboard.

Description of the Related Art

The construction of walls using thermal insulation materials is time and labor consuming, and the construction quality thereof is difficult to control. In addition, the constructed walls have poor waterproof properties.

Typically, in the process of building walls, first, boards are first produced and then concrete is poured. In the maintenance periods of the concrete, the boards need to be dismantled. The boards can only be recycled for 2 to 3 times and then are discarded, which causes waste of resources.

Furthermore, the conventional thermal insulation wallboards are poor in crush resistance, fracture resistance and strength of extension, they can only serve as decorations of the paint layer on the external wall surface.

### SUMMARY OF THE INVENTION

In view of the above described problems, the invention provides a thermal insulation wallboard and a method for producing the same. The thermal insulation wallboard has advantages of light weight, simple structure, high structural strength, good thermal insulation performance and good fireproof and water proof performance. The wide application of the wallboard can save wood resources, protect forests and vegetation and ecological environment directly. Since the wallboards have the advantages of high strength of crush resistance, high strength of fracture resistance and the strength of extension, the block building and ornament materials such as stone and tiles and the building and ornament materials with the larger unit weight can be supported on the external surface of the non-dismantling thermal insulation wallboard as decorative materials for external walls so as to make the external wall decoration effect richer and more beautiful. Since the fireproof performance of the wallboard can reach the class A level, the products are an incombustible material and can completely prevent fire and improve the fire protection performance.

To achieve the above objective, in accordance with one embodiment of the invention, there is provided a thermal insulation wallboard comprising a thermal insulation board, a first hardened resin layer, a first alkali-resistant glass cloth, a second hardened resin layer, a third hardened resin layer, a second alkali-resistant glass cloth, a fourth hardened resin layer and waterproof interface layers. The first hardened resin layer is arranged on one side of the thermal insulation board. The first alkali-resistant glass cloth is arranged on the external part of the first hardened resin layer. The second hardened resin layer is arranged on the external part of the first alkali-resistant glass cloth. The third hardened resin layer is arranged on the other side of the thermal insulation board. The second alkali-resistant glass cloth is arranged on the external part of the third hardened resin layer. The fourth hardened resin layer is arranged on the external part of the second alkali-resistant glass cloth.

The waterproof interface layers are arranged around the thermal insulation board and on both sides of the second and fourth hardened resin layers.

The thermal insulation board is made of mineral cotton and expanded perlite composite materials.

The four hardened resin layers are all hardened melamine resin layers, hardened urea resin layers or hardened phenolic resin layers which have the advantages of good flame-retardant and waterproof performance and high hardness.

The waterproof interface layers adopt acrylic emulsion to paint or pure acrylic emulsion to cover the thermal insulation board all around and both sides of the second and fourth hardened resin layers. The acrylic emulsion solidifies to form the waterproof interface layers which perform connecting and waterproof functions between the thermal insulation boards and concrete and mortar.

Anchor bolts are arranged on the non-dismantling thermal insulation wallboard and are used to fixedly connect the non-dismantling thermal insulation board with concrete walls.

The production method for the thermal insulation wallboard adopts the following steps:

1. Production of the thermal insulation board:

1) Mix mineral cotton, expanded perlite, starch, waterproof agents, fire retardants, flocculating agents, fiberglass, paper pulp and water in proportion to their weights. Put the mixture into the stirring tank until the mixture becomes paste which is made into wet boards by full-hole grouting method, in which, the proportions of mineral cotton, expanded perlite, starch, waterproof agents, fire retardants, flocculating agents, fiberglass, paper pulp and water are as follows:
Mineral Cotton 1,
Expanded Perlite 0.4-0.5,
Starch 0.1-0.2,
Waterproof Agent 0.03-0.05,

0Fire Retardant 0.1-0.2,
Flocculating Agent 0.03-0.05,
Fiberglass 0.01-0.02,
Paper Pulp 0.03-0.05, and
Water 150-200.

The starch is corn starch or cassava starch.

The waterproof agent is the acrylic emulsion, the pure acrylic emulsion or the

EVA emulsion.

The fire retardant is one or a mixture of magnesium hydroxide, aluminum phosphate, monopotassium phosphate and aluminum hydroxide available on the market.

The flocculating agent is aluminum sulfate available on the market.

The mineral cotton, the expanded perlite, the fiberglass and the paper pulp are all materials available on the market.

2) The wet boards are transported into a drying tunnel to be dried at the temperature ranging from 220° C. to 270° C. for 5 to 6 hours to produce thermal insulation board bases.

3) The thermal insulation board bases are sanded and polished to produce the thermal insulation boards.

2. The first resin layer is spread on and covers one side of the thermal insulation board. The first alkali-resistant glass cloth is arranged on the external part of the first resin layer. The second resin layer is spread on and covers the external part of the first alkali-resistant glass cloth. The third resin layer is spread on and covers the other side of the thermal insulation board. The second alkali-resistant glass cloth is arranged on the external part of the third resin layer. The fourth resin layer is spread on and covers the external part of the second alkali-resistant glass cloth. The resin all adopts melamine resin, urea resin or phenolic resin.

3. The thermal insulation board which is painted and covered with resin layers and arranged with the alkali-resistant glass cloth is transported into a pressure tank for negative pressure treatment at the negative pressure ranging from −0.75 MPa to −0.95 MPa for 3 to 5 minutes and for positive pressure treatment at the positive pressure ranging from 0.8 MPa to 1.0 MPa for 3 to 5 minutes so as to make resin enter the thermal insulation board. After the pressure treatment, the thermal insulation board is transported into a hot press for thermosetting treatment of resin with the solidification pressure ranging from 1.2 MPa to 1.5 MPa, the thermosetting temperature ranging from 180° C. to 220° C. and the thermosetting time ranging from 8 to 10 minutes.

4. After the thermosetting treatment, the thermal insulation board is transported into an air channel for cooling to remove water steam and strange smells caused by thermosetting treatment to quickly harden resin coatings so that the four resin layers are respectively hardened into four hardened resin layers.

The four hardened resin layers are all hardened melamine resin layers, hardened urea resin layers or hardened phenolic resin layers which have the advantages of good flame-retardant and waterproof performance and high hardness.

5. After the cooling and thermosetting treatment, the thermal insulation board undergoes polishing and dust removal treatment and is transported to a cutter for two-dimension cutting to cut the thermal insulation board into boards with required specifications.

6. The thermal insulation board which is cut into boards with required specifications is transported to an automatic coating machine to spray the waterproof interface agent from six sides and then to a drying room for drying at the temperature ranging from 75° C. to 100° C. for 45 to 65 minutes. After the drying, the waterproof interface layers are formed around the thermal insulation board and on both sides of the second hardened resin layer and the resin layers so that the non-dismantling thermal insulation board is produced.

The waterproof agent is the acrylic emulsion or the pure acrylic emulsion.

The thermal insulation wallboard and a method for producing the same have the advantages as follows:

1. It is easy to install and use the thermal insulation wallboards, which can save about 30% of the labor.

2. The thermal insulation wallboards are not dismantled in construction. In construction, concrete is poured onto the boards of the internal and external walls. The boards after the concrete placement are directly used as thermal insulation boards of internal and external walls, which can save 35% to 40% of the comprehensive cost. The boards can completely replace class A thermal insulation wallboard. Compared to the class A thermal insulation wallboard and building boards, the products can save the comprehensive cost.

3. Due to the non-dismantling technology, the wallboard of the invention can save 2 to 3 months in term of time limit for construction.

The wallboards realize the integration of thermal insulation boards and non-dismantling thermal insulation boards. The products have the advantages of light weight, simple structure, high structural strength, good thermal insulation performance and good fireproof and water proof performance. The wide application of the products can save a lot of limited wood resources, protect forests and vegetation and our ecological environment directly. Since the boards have the advantages of high strength of crush resistance, high strength of fracture resistance and the strength of extension, the block building and ornament materials with the larger unit weight such as stone and tiles can be supported on the external surface of the non-dismantling thermal insulation wallboard as decorative materials for external walls so as to make the external wall decoration effect richer and more beautiful. Since the fireproof performance of the boards can reach the class A level, the products are an incombustible material and can completely prevent building wall fire and improve the building fire protection performance.

### BRIEF DESCRIPTION OF THE DRAWINGS

The invention is described hereinbelow with reference to the accompanying drawings, in which:

FIG. 1 is a structural diagram of a thermal insulation wallboard of the invention; and

FIG. 2 is a diagram of a thermal insulation wallboard of the invention in use.

### DETAILED DESCRIPTION OF THE EMBODIMENTS

For further illustrating the invention, experiments detailing a thermal insulation wallboard and a method for producing the same are described below. It should be noted that the following examples are intended to describe and not to limit the invention.

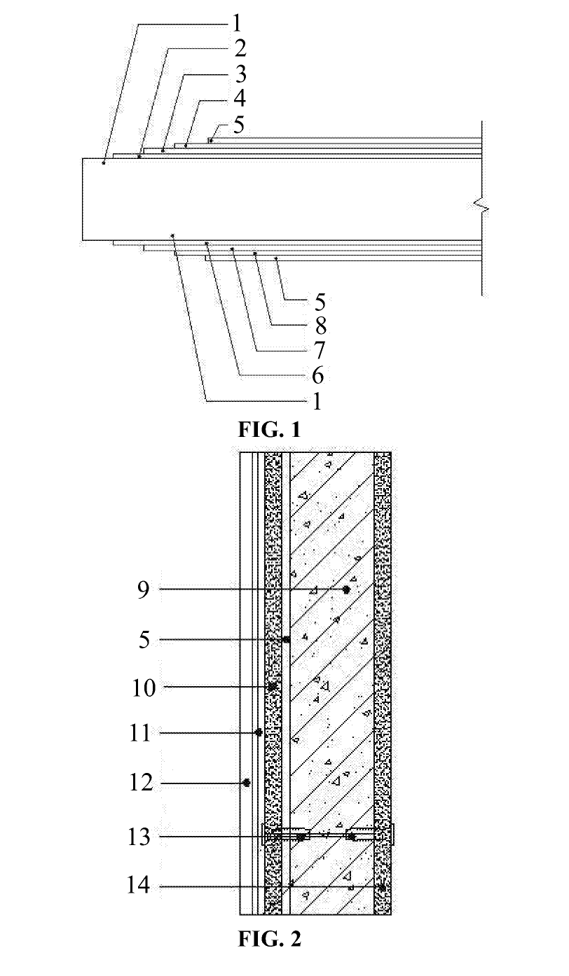

According to FIGS. 1-2, the thermal insulation wallboard comprises a thermal insulation board 1, a first hardened resin layer 2, a first alkali-resistant glass cloth 3, a second hardened resin layer 4, a third hardened resin layer 6, a second alkali-resistant glass cloth 7, a fourth hardened resin layer 8 and waterproof interface layers 5. The first hardened resin layer 2 is arranged on one side of the thermal insulation board 1. The first alkali-resistant glass cloth 3 is arranged on the external part of the first hardened resin layer 2. The second hardened resin layer 4 is arranged on the external part of the first alkali-resistant glass cloth 3. The third hardened resin layer 6 is arranged on the other side of the thermal insulation board 1. The second alkali-resistant glass cloth 7 is arranged on the external part of the third hardened resin layer 6. The fourth hardened resin layer 8 is arranged on the external part of the second alkali-resistant glass cloth 7.

The waterproof interface layers 5 are arranged around the thermal insulation board 1 and on both sides of the second hardened resin layer 4 and fourth hardened resin layer 8.

The thermal insulation board 1 is made out of mineral cotton and expanded perlite composite materials.

The first hardened resin layer 2, second hardened resin layer 4, third hardened resin layer 6 and fourth hardened resin layer 8 are all hardened melamine resin layers, hardened urea resin layers or hardened phenolic resin layers which have the advantages of good flame-retardant and waterproof performance and high hardness.

The waterproof interface layers 5 adopt acrylic emulsion to paint or pure acrylic emulsion to cover the thermal insulation board 1 all around and both sides of the second hardened resin layer 4 and fourth hardened resin layer 8. The acrylic emulsion solidifies to form the waterproof interface layers which perform connecting and waterproof functions between the thermal insulation boards and concrete and mortar.

Anchor bolts are arranged on the non-dismantling thermal insulation board and are used to fixedly connect the non-dismantling thermal insulation board with concrete walls.

### EXAMPLE 1

The production method for the non-dismantling thermal insulation wallboard adopts the following steps:

1. Production of the thermal insulation board:

1) Mix mineral cotton, expanded perlite, starch, waterproof agents, fire retardants, flocculating agents, fiberglass, paper pulp and water in proportion to their weights. Put the mixture into the stirring tank until the mixture becomes paste which is made into wet boards by full-hole grouting method, in which, the proportions of mineral cotton, expanded perlite, starch, waterproof agents, fire retardants, flocculating agents, fiberglass, paper pulp and water are as follows:
Mineral Cotton 1,
Expanded Perlite 0.4,
Corn Starch 0.1,
Waterproof Agent (Acrylic Emulsion) 0.03,
The Fire Retardant (Magnesium Hydroxide) 0.1,
The Flocculating Agent (Aluminum Sulfate) 0.03,
Fiberglass 0.02,
Paper Pulp 0.03, and
Water 150.

2) The wet boards are transported into a drying tunnel to be dried at the temperature ranging from 220° C. to 270° C. for 5 to 6 hours to produce thermal insulation board bases.

3) The thermal insulation board bases are sanded and polished to produce the thermal insulation boards.

The starch is corn starch or cassava starch.

The waterproof agent is the acrylic emulsion, the pure acrylic emulsion or the EVA emulsion.

The fire retardant is one or a mixture of magnesium hydroxide, aluminum phosphate, monopotassium phosphate and aluminum hydroxide available on the market.

The flocculating agent is aluminum sulfate available on the market.

The mineral cotton, the expanded perlite, the fiberglass and the paper pulp are all materials available on the market.

2. The first resin layer is spread on and covers one side of the thermal insulation board. The first alkali-resistant glass cloth is arranged on the external part of the first resin layer. The second resin layer is spread on and covers the external part of the first alkali-resistant glass cloth. The third resin layer is spread on and covers the other side of the thermal insulation board. The second alkali-resistant glass cloth is arranged on the external part of the third resin layer. The fourth resin layer is spread on and covers the external part of the second alkali-resistant glass cloth. The resin all adopts melamine resin, urea resin or phenolic resin.

3. The thermal insulation board which is painted and covered with resin layers and arranged with the alkali-resistant glass cloth is transported into a pressure tank for negative pressure treatment at the negative pressure ranging from −0.75 MPa to −0.95 MPa for 3 to 5 minutes and for positive pressure treatment at the positive pressure ranging from 0.8 MPa to 1.0 MPa for 3 to 5 minutes so as to make resin enter the thermal insulation board. After the pressure treatment, the thermal insulation board is transported into a hot press for thermosetting treatment of resin with the solidification pressure ranging from 1.2 MPa to 1.5 MPa, the thermosetting temperature ranging from 180° C. to 220° C. and the thermosetting time ranging from 8 to 10 minutes.

4. After the thermosetting treatment, the thermal insulation board is transported into an air channel for cooling to remove water steam and strange smells caused by thermosetting treatment to quickly harden resin coatings so that the four resin layers are respectively hardened into four hardened resin layers.

5. After the cooling and thermosetting treatment, the thermal insulation board undergoes polishing and dust removal treatment and is transported to a cutter for two-dimension cutting to cut the thermal insulation board into boards with required specifications.

6. The thermal insulation board which is cut into boards with required specifications is transported to an automatic coating machine to spray the waterproof interface agent from six sides and then to a drying room for drying at the temperature ranging from 75° C. to 100° C. for 45 to 65 minutes. After the drying, the waterproof interface layers are formed around the thermal insulation board and on both sides of the second hardened resin layer and the resin layers so that the non-dismantling thermal insulation board is produced.

### EXAMPLE 2

The production method for the non-dismantling thermal insulation wallboard adopts the following steps:

1. Production of the thermal insulation board:

1) Mix mineral cotton, expanded perlite, starch, waterproof agents, fire retardants, flocculating agents, fiberglass, paper pulp and water in proportion to their weights. Put the mixture into the stirring tank until the mixture becomes paste which is made into wet boards by full-hole grouting method, in which, the proportions of mineral cotton, expanded perlite, starch, waterproof agents, fire retardants, flocculating agents, fiberglass, paper pulp and water are as follows:
Mineral Cotton 1,
Expanded Perlite 0.5,
Cassava Starch 0.2,
The Waterproof Agent (Pure Acrylic Emulsion) 0.05,
The Fire Retardant (Aluminum Phosphate) 0.1,
The Fire Retardant (Monopotassium Phosphate) 0.1,
The Flocculating Agent (Aluminum Sulfate) 0.05,
Fiberglass 0.01,
Paper Pulp 0.05, and
Water 200.

2) The wet boards are transported into a drying tunnel to be dried at the temperature ranging from 220° C. to 270° C. for 5 to 6 hours to produce thermal insulation board bases.

3) The thermal insulation board bases are sanded and polished to produce the thermal insulation boards.

The starch is corn starch or cassava starch.

The waterproof agent is the acrylic emulsion, the pure acrylic emulsion or the EVA emulsion.

The fire retardant is one or a mixture of magnesium hydroxide, aluminum phosphate, monopotassium phosphate and aluminum hydroxide available on the market.

The flocculating agent is aluminum sulfate available on the market.

The mineral cotton, the expanded perlite, the fiberglass and the paper pulp are all materials available on the market.

2. The first resin layer is spread on and covers one side of the thermal insulation board. The first alkali-resistant glass cloth is arranged on the external part of the first resin layer. The second resin layer is spread on and covers the external part of the first alkali-resistant glass cloth. The third resin layer is spread on and covers the other side of the thermal insulation board. The second alkali-resistant glass cloth is arranged on the external part of the third resin layer. The fourth resin layer is spread on and covers the external part of the second alkali-resistant glass cloth. The resin all adopts melamine resin, urea resin or phenolic resin.

3. The thermal insulation board which is painted and covered with resin layers and arranged with the alkali-resistant glass cloth is transported into a pressure tank for negative pressure treatment at the negative pressure ranging from −0.75 MPa to −0.95 MPa for 3 to 5 minutes and for positive pressure treatment at the positive pressure ranging from 0.8 MPa to 1.0 MPa for 3 to 5 minutes so as to make resin enter the thermal insulation board. After the pressure treatment, the thermal insulation board is transported into a hot press for thermosetting treatment of resin with the solidification pressure ranging from 1.2 MPa to 1.5 MPa, the thermosetting temperature ranging from 180° C. to 220° C. and the thermosetting time ranging from 8 to 10 minutes.

4. After the thermosetting treatment, the thermal insulation board is transported into an air channel for cooling to remove water steam and strange smells caused by thermosetting treatment to quickly harden resin coatings so that the four resin layers are respectively hardened into four hardened resin layers.

5. After the cooling and thermosetting treatment, the thermal insulation board undergoes polishing and dust removal treatment and is transported to a cutter for two-dimension cutting to cut the thermal insulation board into boards with required specifications.

6. The thermal insulation board which is cut into boards with required specifications is transported to an automatic coating machine to spray the waterproof interface agent from six sides and then to a drying room for drying at the temperature ranging from 75° C. to 100° C. for 45 to 65 minutes. After the drying, the waterproof interface layers are formed around the thermal insulation board and on both sides of the second hardened resin layer and the resin layers so that the non-dismantling thermal insulation board is produced.

Example 3

The production method for the non-dismantling thermal insulation wallboard adopts the following steps:

1. Production of the thermal insulation board:

1) Mix mineral cotton, expanded perlite, starch, waterproof agents, fire retardants, flocculating agents, fiberglass, paper pulp and water in proportion to their weights. Put the mixture into the stirring tank until the mixture becomes paste which is made into wet boards by full-hole grouting method, in which, the proportions of mineral cotton, expanded perlite, starch, waterproof agents, fire retardants, flocculating agents, fiberglass, paper pulp and water are as follows:
Mineral Cotton 1,
Expanded Perlite 0.45,
Corn Starch 0.15,
The Waterproof Agent (EVA Emulsion) 0.04,
The Fire Retardant (Aluminum Hydroxide) 0.15,
The Flocculating Agent (Aluminum Sulfate) 0.04,
Fiberglass 0.015,
Paper Pulp 0.04, and
Water 175.

2) The wet boards are transported into a drying tunnel to be dried at the temperature ranging from 220° C. to 270° C. for 5 to 6 hours to produce thermal insulation board bases.

3) The thermal insulation board bases are sanded and polished to produce the thermal insulation boards.

The starch is corn starch or cassava starch.

The waterproof agent is the acrylic emulsion, the pure acrylic emulsion or the EVA emulsion.

The fire retardant is one or a mixture of magnesium hydroxide, aluminum phosphate, monopotassium phosphate and aluminum hydroxide available on the market.

The flocculating agent is aluminum sulfate available on the market.

The mineral cotton, the expanded perlite, the fiberglass and the paper pulp are all materials available on the market.

2. The first resin layer is spread on and covers one side of the thermal insulation board. The first alkali-resistant glass cloth is arranged on the external part of the first resin layer. The second resin layer is spread on and covers the external part of the first alkali-resistant glass cloth. The third resin layer is spread on and covers the other side of the thermal insulation board. The second alkali-resistant glass cloth is arranged on the external part of the third resin layer. The fourth resin layer is spread on and covers the external part of the second alkali-resistant glass cloth. The resin all adopts melamine resin, urea resin or phenolic resin.

3. The thermal insulation board which is painted and covered with resin layers and arranged with the alkali-resistant glass cloth is transported into a pressure tank for negative pressure treatment at the negative pressure ranging from −0.75 MPa to −0.95 MPa for 3 to 5 minutes and for positive pressure treatment at the positive pressure ranging from 0.8 MPa to 1.0 MPa for 3 to 5 minutes so as to make resin enter the thermal insulation board. After the pressure treatment, the thermal insulation board is transported into a hot press for thermosetting treatment of resin with the solidification pressure ranging from 1.2 MPa to 1.5 MPa, the thermosetting temperature ranging from 180° C. to 220° C. and the thermosetting time ranging from 8 to 10 minutes.

4. After the thermosetting treatment, the thermal insulation board is transported into an air channel for cooling to remove water steam and strange smells caused by thermosetting treatment to quickly harden resin coatings so that the four resin layers are respectively hardened into four hardened resin layers.

5. After the cooling and thermosetting treatment, the thermal insulation board undergoes polishing and dust removal treatment and is transported to a cutter for two-dimension cutting to cut the thermal insulation board into boards with required specifications.

6. The thermal insulation board which is cut into boards with required specifications is transported to an automatic coating machine to spray the waterproof interface agent from six sides and then to a drying room for drying at the temperature ranging from 75° C. to 100° C. for 45 to 65 minutes. After the drying, the waterproof interface layers are formed around the thermal insulation board and on both sides of the second hardened resin layer and the resin layers so that the non-dismantling thermal insulation board is produced.

According to FIG. 2, when the invention is used for building insulation projects, the non-dismantling thermal insulation boards are cut into boards of required size according to design requirements, and the waterproof interface layer 5 in the form of interface agent is spread on the cut surface. According to design requirements and field dimensions, the cut boards are installed into building boards. The external non-dismantling thermal insulation board 10 and the internal non-dismantling thermal insulation board 14 are fixed with battens and supports. After the required anchor bolts 13 are installed, concrete can be poured. After the pouring of concrete, the concrete 9 is maintained for 3 to 5 days and then the battens on the facade of the concrete can be dismantled. The battens and supports at the bottom of the concrete can be dismantled after the concrete has been maintained for 15 to 25 days. After the battens and supports are dismantled, the maintenance work is completed and the next process can be performed. The surface layer (reinforced net) 11 is spread on the external part of the external non-dismantling thermal insulation board 10. The surface layer (reinforced net) 11 can be used as veneer 12. The non-dismantling thermal insulation board (the external non-dismantling thermal insulation board 10 and the internal non-dismantling thermal insulation board 14) continues to be anchored on wall surface as heat insulating work.

The test results of the wallboards produced in embodiments are as follows:

TABLE 1
Performance Indexes of External Thermal Insulation System
of the thermal insulation board for External Walls

| Item | Performance Index |
|---|---|
| Weather Fastness | No cracking, hollowing, bubbling and |
| | peeling phenomena; tensile adhesive |
| | strength ≧ 0.2 MPa and broken thermal |
| | insulation layers |
| Wind-resistant Load Capacity | Meet design requirements |
| Water Absorbing Capacity | After soaking in water for one hour, the |
| | water absorbing capacity of the system |
| | is ≦0.5 kg/m². |
| Impact Resistance | 10 J |
| Freeze-thaw Resistance | After 30 freeze-thaw cycles, the system |
| Performance | has no hollowing, peeling and cracking |
| | phenomena; tensile adhesive |
| | strength ≧ 0.2 MPa |
| Water Steam Penetration | Meet design requirements; ≧0.85 |
| Resistance | g/(m² · h) |
| Waterproof Performance of the | No water penetration within 2 hours |
| Rendering Layer | |
| Thermal Resistance | Meet design requirements |

TABLE 2
Physical and Mechanical Performance

Unit: millimeter

| Item | Index |
|---|---|
| Density, kg/m³ ≦ | 420 |
| Coefficient of Heat Conductivity, W/(m · K) ≦ | 0.055 |
| Compressive Strength, MPa ≧ | 0.7 |
| Tensile Strength, MPa ≧ | 0.2 |
| Rupture Strength, MPa ≧ | 3.5 |
| Bending Strength, MPa ≧ | 8.0 |
| Modulus of Elasticity, MPa ≧ | 1300 |
| Water Absorption, % ≦ | 3.0 |
| Softening Coefficient ≧ | 0.8 |
| Linear shrinkage, mm/m ≦ | 0.8 |
| pH Value | 7-8 |
| Combustibility | Class A2 |

TABLE 3
Indexes of Interface Agent Properties

| Items | | Indexes |
|---|---|---|
| Tensile adhesive | Original Strength | 0.70 |
| strength, MPa ≧ | Water Resistance | 0.50 |
| | Freeze-thaw Resistance | 0.50 |

Conclusion: according to product tests, the board has the advantages of the light weight, the simple structure, the high structural strength, the good thermal insulation performance and the good fireproof and water proof performance.

The invention claimed is:

1. A thermal insulation wallboard, comprising a thermal insulation board, a first hardened resin layer, a first alkali-resistant glass cloth, a second hardened resin layer, a third hardened resin layer, a second alkali-resistant glass cloth, a fourth hardened resin layer and waterproof interface layers; wherein
the first hardened resin layer is arranged on one side of the thermal insulation board;
the first alkali-resistant glass cloth is arranged on an external part of the first hardened resin layer;
the second hardened resin layer is arranged on an external part of the first alkali-resistant glass cloth;
the third hardened resin layer is arranged on the other side of the thermal insulation board;
the second alkali-resistant glass cloth is arranged on an external part of the third hardened resin layer;
the fourth hardened resin layer is arranged on an external part of the second alkali-resistant glass cloth; and
the waterproof interface layers are arranged around the thermal insulation board and on both sides of the second and fourth hardened resin layers.

2. The wallboard of claim 1, wherein the thermal insulation board is made of mineral cotton and expanded perlite composite materials.

3. The wallboard of claim 1, wherein four hardened resin layers are all hardened melamine resin layers, hardened urea resin layers or hardened phenolic resin layers.

4. The wallboard of claim 1, wherein the waterproof interface layers adopt acrylic emulsion to paint or pure acrylic emulsion to cover the thermal insulation board all around and both sides of the second and fourth hardened resin layers.

5. The wallboard of claim 1, wherein anchor bolts are arranged on the thermal insulation board and are used to fixedly connect the thermal insulation board with concrete walls.

6. A production method for the wallboard of claim 1, comprising:
I) producing the thermal insulation board:
1) mixing mineral cotton, expanded perlite, starch, waterproof agents, fire retardants, flocculating agents, fiberglass, paper pulp and water in proportion by weight, putting mixture into a stirring tank until the mixture becomes paste which is made into wet boards by full-hole grouting method; wherein,
proportions by weight of the mineral cotton, the expanded perlite, the starch, the waterproof agents, the fire retardants, the flocculating agents, the fiberglass, the paper pulp and the water are as follows: the mineral cotton 1, the expanded perlite 0.4-0.5, the starch 0.1-0.2, the waterproof agents 0.03-0.05, the fire retardants 0.1-0.2, the flocculating agents 0.03-0.05, the fiberglass 0.01-0.02, the paper pulp 0.03-0.05, and the water 150-200;
2) transporting the wet boards into a drying tunnel and drying the wet boards at a temperature ranging from 220° C. to 270° C. for 5 to 6 hours to produce thermal insulation board bases; and
3) sanding and polishing the thermal insulation board bases to produce the thermal insulation board;
II) spreading on a first resin layer to cover one side of the thermal insulation board, arranging the first alkali-resistant glass cloth on an external part of the first resin layer, spreading on a second resin layer to cover the external part of the first alkali-resistant glass cloth, spreading on a third resin layer to cover the other side of the thermal insulation board, arranging the second alkali-resistant glass cloth on an external part of the third resin layer, and spreading on a fourth resin layer to cover the external part of the second alkali-resistant glass cloth;
III) transporting the thermal insulation board which is painted and covered with resin layers and arranged with alkali-resistant glass cloth into a pressure tank, for negative pressure treatment at a negative pressure ranging from −0.75 MPa to −0.95 MPa for 3 to 5 minutes, and for positive pressure treatment at a positive pressure ranging from 0.8 MPa to 1.0 MPa for 3 to 5 minutes, so as to make resin enter the thermal insulation board, transporting the thermal insulation board into a hot press for thermosetting treatment of the resin with a solidification pressure ranging from 1.2 MPa to 1.5 MPa after pressure treatment, ranging a thermosetting temperature from 180° C. to 220° C., and ranging a thermosetting time from 8 to 10 minutes;
IV) transporting the thermal insulation board into an air channel for cooling to remove water steam and strange smells caused by the thermosetting treatment to quickly harden resin coatings so that the four resin layers are respectively hardened into four hardened resin layers after the thermosetting treatment;
V) polishing and cleaning the thermal insulation board and transporting the thermal insulation board to a cutter for two-dimension cutting to cut the thermal insulation board into boards with required specifications after the cooling and thermosetting treatment; and
VI) transporting the thermal insulation board which is cut into the boards with the required specifications to an automatic coating machine to spray waterproof interface agent from six sides and then to a drying room for drying at a temperature ranging from 75° C. to 100° C. for 45 to 65 minutes, and forming the waterproof interface layers around the thermal insulation board and on both sides of the second hardened resin layer and the resin layers.

7. The method of claim 6, wherein the starch is corn starch or cassava starch.

8. The method of claim 6, wherein the waterproof agents are acrylic emulsion, pure acrylic emulsion or EVA emulsion.

9. The method of claim 6, wherein the fire retardants are one or a mixture of magnesium hydroxide, aluminum phosphate, monopotassium phosphate, and aluminum hydroxide.

10. The method of claim 6, wherein the flocculating agents are aluminum sulfate.

11. The method of claim 6, wherein the resin all adopts melamine resin, urea resin, or phenolic resin.
